(19) United States
(12) Patent Application Publication
(10) Pub. No.: US 2025/0275072 A1
(43) Pub. Date: Aug. 28, 2025

(54) FOLDABLE DISPLAY APPARATUS AND MANUFACTURING METHOD THEREFOR, AND ELECTRONIC DEVICE

(71) Applicants: Hefei Visionox Technology Co., Ltd., Hefei (CN); KunShan Go-Visionox Opto-Electronics Co., Ltd., Kunshan (CN)

(72) Inventors: Zhengyang LI, Hefei (CN); Fang ZHANG, Hefei (CN); Chang LIN, Hefei (CN); Chia-Huan CHANG, Hefei (CN); Xiujian ZHU, Hefei (CN)

(73) Assignees: Hefei Visionox Technology Co., Ltd., Hefei (CN); KunShan Go-Visionox Opto-Electronics Co., Ltd., Kunshan (CN)

(21) Appl. No.: 19/205,910

(22) Filed: May 12, 2025

Related U.S. Application Data
(63) Continuation of application No. PCT/CN2023/080404, filed on Mar. 9, 2023.

(30) Foreign Application Priority Data
Nov. 23, 2022 (CN) 202211476840.6

(51) Int. Cl. H05K 5/02

(52) U.S. Cl. CPC H05K 5/0217

(57) ABSTRACT

The present application discloses a foldable display apparatus and a manufacturing method therefor, and an electronic device. The foldable display apparatus includes a screen and a supporting structure. The supporting structure includes two supporting assemblies. Each supporting assembly includes a first supporting part and a second supporting part spaced apart from each other. The supporting structure is designed according to at least one established empirical formula. Each of the at least one empirical formula includes at least one first feature parameter and a plurality of second feature parameters. The at least one first feature parameter includes a spacing between the first supporting part and the second supporting part in a flat state or a deflection angle of the second supporting part relative to the first supporting part in a bending state. The plurality of second feature parameters are determined according to form design requirements of the screen.

### CROSS-REFERENCE TO RELATED APPLICATIONS

The present application a continuation of International Application No. PCT/CN 2023/080404, filed on Mar. 9, 2023, which claims priority to Chinese Patent Application No. 202211476840.6, filed on Nov. 23, 2022. All of the aforementioned patent applications are hereby incorporated by reference in their entireties.

### FIELD

The present application relates to the field of display, and in particular to a foldable display apparatus and a manufacturing method therefor, and an electronic device.

### BACKGROUND

A flexible display screen may be in special product forms such as folding, large-angle bending and rolling, and thus has been used more and more. For example, a foldable display screen may have a larger display area in a flat state; and when the display screen is in a bending state, the whole apparatus may be small in size and easier to carry, which has attracted wide attention.

In the related art, a foldable display apparatus may include a support member and a flexible screen fixed to the support member. The support member has a mechanical strength and may support the flexible screen.

The foldable display apparatus may be bent repeatedly during use. Therefore, the reliability of the foldable display apparatus is an important challenge in the art.

### SUMMARY OF THE DISCLOSURE

Embodiments of the present application provide a foldable display apparatus and a manufacturing method therefor, and an electronic device, which help to improve the reliability of the foldable display apparatus and the electronic device.

An embodiment of the present application provides a foldable display apparatus having a flat state and a bending state, including:
a screen including two non-bendable areas and a bendable area located between adjacent non-bendable areas, in the flat state, the adjacent non-bendable areas being located on two sides of the bendable area in a first direction; and
a supporting structure including two supporting assemblies, the two supporting assemblies being located on two sides of a bending axis of the bendable area, respectively, each supporting assembly including a first supporting part and a second supporting part spaced apart from each other, each first supporting part being arranged to at least partially correspond to a non-bendable area, and each second supporting part being arranged on a side of the bendable area away from the bending axis,
wherein the supporting structure is designed according to at least one established empirical formula, each of the at least one established empirical formula including at least one first feature parameter and a plurality of second feature parameters, the at least one first feature parameter being design parameter of the supporting structure and including at least a spacing between the first supporting part and the second supporting part in the flat state or a deflection angle of the second supporting part relative to the first supporting part in the bending state; and the plurality of second feature parameters are determined according to form design requirements of the screen.

An embodiment of the present application provides a method for manufacturing a foldable display apparatus having a flat state and a bending state, the foldable display apparatus including:
a screen including two non-bendable areas and a bendable area located between the adjacent non-bendable areas, in the flat state, the adjacent non-bendable areas being located on two sides of the bendable area in a first direction; and
a supporting structure including two supporting assemblies, the two supporting assemblies being located on two sides of a bending axis of the bendable area, respectively, each supporting assembly including a first supporting part and a second supporting part spaced apart from each other, each first supporting part being arranged to at least partially correspond to a non-bendable area, and each second supporting part being arranged on a side of the bendable area away from the bending axis; and
the manufacturing method including:
obtaining at least one empirical formula, each of the at least one empirical formula including at least one first feature parameter and a plurality of second feature parameters, the at least one first feature parameter being design parameter of the supporting structure and including at least a spacing between the first supporting part and the second supporting part in the flat state or a deflection angle of the second supporting part relative to the first supporting part in the bending state;
determining the plurality of second feature parameters according to form design requirements of the screen; and
determining the at least one first feature parameter by substituting the plurality of second feature parameters into the empirical formula.

An embodiment of the present application provides an electronic device, including a foldable display apparatus as described in any one of the embodiments.

According to the foldable display apparatus and the manufacturing method therefor, and the electronic device provided in the embodiments of the present application, instead of arbitrarily setting parameters of the supporting structure, morphology parameters of the foldable display apparatus are designed controllably according to the established empirical formula, so that dimensions of key parameters of the foldable display apparatus can be optimized and designed to help to achieve an optimal waterdrop stress pattern, which can help to avoid stress concentration in the screen, optimize the stress on the waterdrop bendable area, and alleviate the problem of peeling of an adhesive layer and the problem of fracture of an inorganic film layer.

### BRIEF DESCRIPTION OF THE DRAWINGS

FIG. 1 is a structural schematic diagram of a foldable display apparatus according to the related art in a bending state;

FIG. 2 is a structural schematic diagram of a foldable display apparatus according to an embodiment of the present application in a flat state;

FIG. 3 is a structural schematic diagram of a foldable display apparatus according to an embodiment of the present application in a bending state;

FIG. 4 is a schematic diagram of parameters of a two-segment free-state waterdrop in the bending state according to an embodiment of the present application;

FIG. 5 is a schematic diagram of a relationship between two angles of a foldable display apparatus according to an embodiment of the present application;

FIG. 6 is another structural schematic diagram of a foldable display apparatus according to an embodiment of the present application in the flat state;

FIG. 7 is a yet another structural schematic diagram of a foldable display apparatus according to an embodiment of the present application; and

FIG. 8 is a schematic flowchart of a method for manufacturing a foldable display apparatus according to an embodiment of the present application.

### DETAILED DESCRIPTION OF THE EMBODIMENTS

Various modifications and variations can be made in the present application without departing from the spirit or scope of the present application. Therefore, the present application aims to cover the modifications and variations that fall within the scope of the corresponding claims (the claimed embodiments) and equivalents thereof. Implementations provided in the embodiments of the present application may be combined with each other without contradiction.

Before elaborating on the embodiments of the present application, to facilitate understanding of the embodiments of the present application, the problems existing in the related art are specifically listed in the present application.

In order to improve the flatness of a screen, as shown in FIG. 1, supporting parts may be provided corresponding to a non-bendable area and a bendable area of the screen. For ease of distinction, the supporting part provided corresponding to the non-bendable area of the screen is labeled as a supporting part 11, and the supporting part provided corresponding to the bendable area of the screen is labeled as a supporting part 12. The supporting part 11 and the supporting part 12 may be flipped around a pivot (not shown in FIG. 1) of a foldable display apparatus, and the screen may be bent with the flipping of the supporting parts. For example, the screen may be folded into the shape of a waterdrop. Through research, the inventors found that during flipping of the supporting part 11 and the supporting part 12, an end of the supporting part 11 close to the supporting part 12 may press the screen, and an end of the supporting part 12 close to the supporting part 11 may press the screen. However, the supporting part has a certain mechanical strength, as mentioned in the Background, and the foldable display apparatus may be bent repeatedly during use, so that the end of the supporting part 11 close to the supporting part 12 and the end of the supporting part 12 close to the supporting part 11 may repeatedly press the screen, which affects the reliability of the screen and may cause the screen to be damaged or have poor display.

In order to solve the above-mentioned problems, embodiments of the present application provide a foldable display apparatus and a manufacturing method therefor, and an electronic device, and various embodiments of the foldable display apparatus and the manufacturing method therefor, and the electronic device will be described below with reference to the accompanying drawings.

The foldable display apparatus provided in the embodiment of the present application will be first described below.

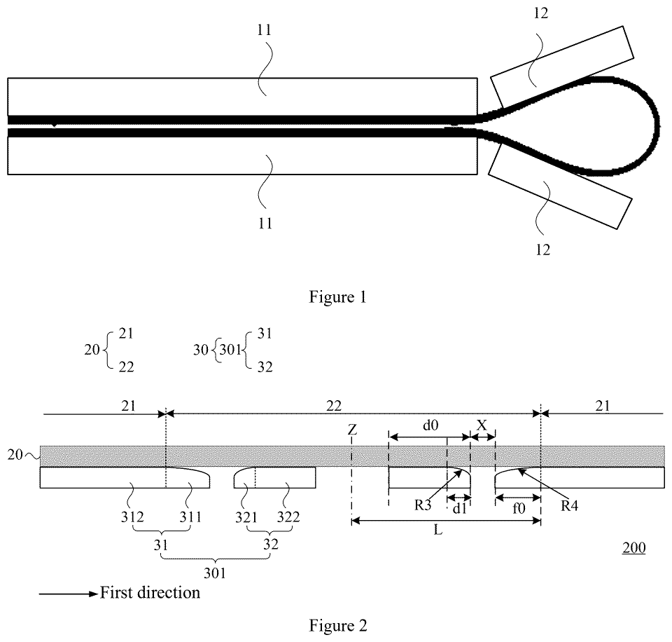

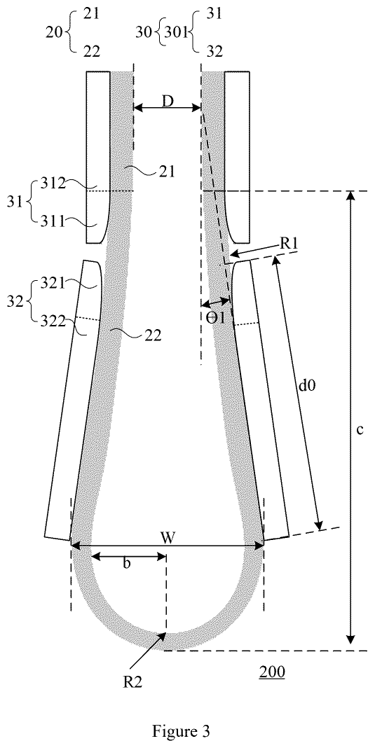

FIG. 2 is a structural schematic diagram of a foldable display apparatus according to an embodiment of the present application in a flat state. FIG. 3 is a structural schematic diagram of a foldable display apparatus according to an embodiment of the present application in a bending state. As shown in FIGS. 1 and 2, the foldable display apparatus 200 provided in the embodiment of the present application may include a screen 20 and a supporting structure 30. The supporting structure 30 is configured to support the screen 20. The screen 20 may include a light-emitting surface and a non-light-emitting surface opposite the light-emitting surface. The supporting structure 30 may be arranged on the non-light-emitting surface of the screen 20.

The screen 20 includes two non-bendable areas 21 and a bendable area 22 between the adjacent non-bendable areas 21. In the flat state, the adjacent non-bendable areas 21 are located on two sides of the bendable area 22 in a first direction. The supporting structure 30 may include two supporting assemblies 301. The two supporting assemblies 301 are located on two sides of a bending axis Z of the bendable area 22, respectively. In other words, the two supporting assemblies 301 may be arranged corresponding to the bendable area 22 and the two non-bendable areas on the two sides of the bendable area 22. Specifically, each supporting assembly 301 may include two supporting parts spaced apart from each other, one of which is arranged corresponding to the non-bendable area 21 and the other of which is arranged corresponding to the bendable area 22. At least one of the two supporting parts of the same supporting assembly 301 includes a transition area. The transition area is close to the other supporting part, and a surface of the supporting part facing the screen 20 in the transition area is an arc surface.

For case of understanding, the supporting part arranged corresponding to the non-bendable area 21 is herein referred to as a first supporting part 31, and the supporting part arranged corresponding to the bendable area 22 is herein referred to as a second supporting part 32. At least one of the first supporting part 31 and the second supporting part 32 may include a transition area. The accompanying drawings herein are illustrated in an example of each of the first supporting part 31 and the second supporting part 32 including the transition area, which is not intended to limit the present application. In addition, for case of distinction, the transition area of the first supporting part 31 is referred to as a first transition area 311, and the first transition area 311 is close to the second supporting part 32. The transition area of the second supporting part 32 is referred to as a second transition area 321, and the second transition area 321 is close to the first supporting part 31. Each of surfaces of the supporting parts facing the screen 20 in the first transition area 311 and the second transition area 321 is an arc surface.

According to the foldable display apparatus provided in the embodiment of the present application, at least one of the first supporting part 31 and the second supporting part 32 may include the transition area, and the surface of the supporting part facing the screen 20 in the transition area is the arc surface, which, during bending of the foldable display apparatus, can reduce the possibility of an end of the first supporting part 31 close to the second supporting part 32 and an end of the second supporting part 32 close to the first supporting part 31 coming into contact with the screen 20, and in turn reduce the possibility of the end of the first supporting part 31 close to the second supporting part 32 and the end of the second supporting part 32 close to the first supporting part 31 pressing the screen 20, thus helping to improve the reliability of the screen 20 and preventing the screen from being damaged or having poor display.

In one or more embodiments, a surface of the supporting part facing the screen 20 in the transition area is an arc surface, and the arc surface protrudes toward the screen 20.

By way of example, an area in the first supporting part 31 outside the first transition area 311 is referred to as a first non-transition area 312, and a surface of the first supporting part 31 facing the screen 20 in the first non-transition area 312 may be planar. It will be understood that the first supporting part 31 may be in smooth transition between the first transition area 311 and the first non-transition area 312, and the first supporting part 31 has no tip at the connection between the first transition area 311 and the first non-transition area 312. The position of the first transition area 311 may correspond to the position of the bendable area 22 of the screen 20, and the position of the first non-transition area 312 may correspond to the position of the non-bendable area 21 of the screen.

An area in the second supporting part 32 outside the second transition area 321 is referred to as a second non-transition area 322, and a surface of the second supporting part 32 facing the screen 20 in the second non-transition area 322 may be planar. It will be understood that the second supporting part 32 may be in smooth transition between the second transition area 321 and the second non-transition area 322, and the second supporting part 32 has no tip at the connection between the second transition area 321 and the second non-transition area 322.

By way of example, a surface of the first supporting part 31 facing away from the screen 20 in the first transition area 311 may be planar, and a surface of the second supporting part 32 facing away from the screen 20 in the second transition area 321 may be planar. In addition, a surface of the first supporting part 31 facing away from the screen 20 in the first non-transition area 312 may be planar, and a surface of the second supporting part 32 facing away from the screen 20 in the second non-transition area 322 may be planar.

By way of example, in the flat state, the surface of the first supporting part 31 facing away from the screen 20 and the surface of the second supporting part 32 facing away from the screen 20 may be in the same plane.

In an embodiment of the present application, the arc surface of the supporting part in the transition area protrudes toward the screen, so that the supporting part can be in smooth transition between the transition area and the non-transition area connected to the transition area, avoiding the presence of a tip of the supporting part at the connection between the transition area and the non-transition area, and thus further reducing the possibility of the supporting part pressing the screen.

With continued reference to FIG. 2, the arc surface protrudes toward the screen 20. The foldable display apparatus includes the flat state and the bending state. In the flat state, in the same supporting assembly, a gap between the arc surface of the supporting part having the transition area and the screen gradually increases in a direction from the supporting part toward the other supporting part. In an example of the first supporting part 31 having the transition area, in the flat state, a gap between the arc surface of the first supporting part 31 and the screen 20 may gradually increase in a direction from the first supporting part 31 toward the second supporting part 32. In an example of the second supporting part 32 having the transition area, in the flat state, a gap between the arc surface of the second supporting part 32 and the screen 20 may gradually increase in a direction from the second supporting part 32 toward the first supporting part 31. In this way, the possibility of the supporting part pressing the screen during bending can be further reduced.

In an embodiment of the present application, the foldable display apparatus may be an inward-bending display apparatus, and the supporting structure 30 is located on the side of the non-light-emitting surface of the screen 20 opposite the light-emitting surface. In the bending state, the light-emitting surface of the screen 20 is located inside of the non-light-emitting surface of the screen 20 opposite the light-emitting surface.

The inventors also found that a foldable flexible display screen is susceptible to the risk of fracture when subjected to long-term cyclical bending. In the bending state, by setting the bendable area of the screen to be in the form of a waterdrop in the bending state, the radius of the bendable area increases, which can effectively reduce the risk of fracture of the screen during bending and improve the bending performance of the foldable display apparatus. In the related art, morphology parameters of the specified radius of the waterdrop bendable area can be realized only by means of simulation and mechanism design, which is time-consuming and labor-intensive, and when a mechanism moving trajectory is not well-designed, the morphology parameters of the specified radius of the waterdrop bendable area cannot be controlled preferably or optimally. However, the morphology parameters of the waterdrop bendable area directly determine stress relief of all laminates in the bendable area of the screen, and when the morphology parameters cannot be controlled preferably or optimally, it is likely to cause problems such as peeling of an adhesive layer in the bendable area and fracture of an inorganic film layer in a central bending area.

Through long-term research, the inventors derived at least one empirical formula from the relationship between the waterdrop morphology parameters of the bendable area of the screen in the bending state, and the supporting structure can be designed according to the established empirical formula. Specifically, the empirical formula includes at least one first feature parameter and a plurality of second feature parameters. The at least one first feature parameter is design parameter of the supporting structure and includes at least a spacing between the first supporting part and the second supporting part in the flat state or a deflection angle of the second supporting part relative to the first supporting part in the bending state, or the at least one first feature parameter includes a plurality of first feature parameters, the plurality of first feature parameters are design parameters of the supporting structure and include at least a spacing between the first supporting part and the second supporting part in the flat state and a deflection angle of the second supporting part relative to the first supporting part in the bending state; and the plurality of second feature parameters are determined according to form design requirements of the screen.

In the embodiments of the present application, instead of arbitrarily setting parameters of the supporting structure, morphology parameters of the foldable display apparatus are designed controllably according to the established empirical formula, so that dimensions of key parameters of the foldable display apparatus can be optimized and designed to help to achieve an optimal waterdrop stress pattern, which can help to avoid stress concentration in the screen, optimize the stress on the waterdrop bendable area, and alleviate the problem of peeling of the adhesive layer and the problem of fracture of the inorganic film layer.

The specific process of deriving the empirical formula is described as below.

For example, a two-segment free-state waterdrop is defined as the case where the supporting part is only arranged corresponding to the non-bendable area of the screen, and a four-segment constrained-state waterdrop is defined as the case where the supporting parts are arranged corresponding to both the non-bendable area and the bendable area of the screen.

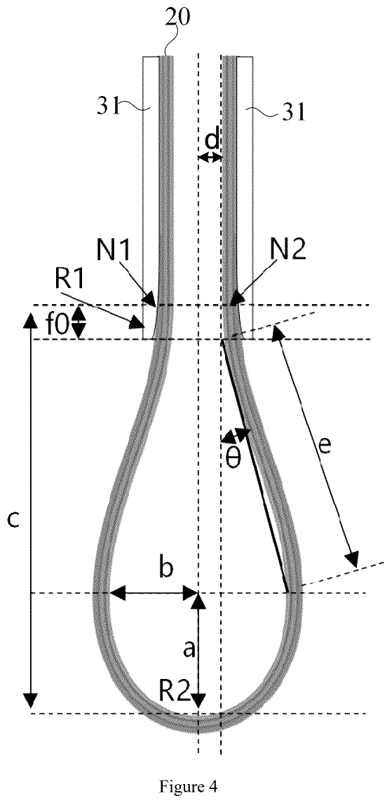

FIG. 4 is a schematic diagram of parameters of a two-segment free-state waterdrop in the bending state. In FIG. 4, only the first supporting part 31 is arranged corresponding to the non-bendable area of the screen 20, and the bendable area of the screen is in the form of a waterdrop in the bending state. The first supporting part 31 may include a transition area, and the transition area of the first supporting part 31 is located on the side of the first supporting part close to the bendable area of the screen. The transition area of the first supporting part 31 may at least partially correspond to the bendable area of the screen 20. The first supporting part 31 is arranged to at least partially correspond to the non-bendable area. The second supporting part 32 is arranged on a side of the bendable area away from the bending axis Z.

In the bending state, the bendable area forms a quasi-semielliptic cylindrical surface and quasi-inclined surfaces on two sides of the quasi-semielliptic cylindrical surface, and the second supporting part 32 is arranged to partially or wholly correspond to the quasi-inclined surface. In FIG. 4, θ denotes an angle between the light-emitting surface of the non-bendable area of the screen 20 and the quasi-inclined surface formed by the light-emitting surface of the bendable area of the screen 20 in the bending state, a denotes a semi-major axis of the quasi-semielliptic cylindrical surface formed by the light-emitting surface of the bendable area of the screen 20 in the bending state, b denotes a semi-minor axis of the quasi-semielliptic cylindrical surface formed by the light-emitting surface of the bendable area of the screen 20 in the bending state, c denotes a length of a waterdrop, d denotes half of a spacing between the light-emitting surfaces of the two non-bendable areas of the screen 20 in the bending state, e denotes an approximate length of a bevel side of the waterdrop formed by the bendable area of the screen 20 in the bending state, f0 denotes a length of the transition area of the first supporting part 31, and R2 denotes a minimum radius of curvature of the quasi-semielliptic cylindrical surface formed by the bendable area of the screen 20 in the bending state. b is equal to half of a spacing between two opposite ends in the first direction of the quasi-semielliptic cylindrical surface formed by the light-emitting surface of the bendable area in the bending state.

In addition, as shown in FIG. 4, the bendable area of the screen is in the form of a waterdrop in the bending state, and a part of the area protrudes inwards. This part of the area may be referred to as a reverse-folded area of the screen 20, and R1 denotes a radius of the reverse-folded area of the screen 20 in the bending state.

For example, L denotes half of a length of the bendable area of the screen 20. As shown in FIG. 4, the two ends of the bendable area of the screen 20 are labeled as N1 and N2, and it may be understood that a length from N1 to N2 is 2 L.

The formula of the perimeter of an ellipse is L0=2πb+4 (a−b), and a lower portion of the waterdrop formed by the bendable area of the screen 20 is half of the ellipse. Therefore, 2 L=2e+2f0+L0/2, further resulting in a relation (1.1):

$$2 e = 2 L - 2 f 0 - L 0 / 2 = 2 L - 2 f 0 - π b - 2 ( a - b ) \qquad ( 1.1 )$$

$$That is , e = \frac{2 L - 2 f 0 - π b - 2 ( a - b )}{2} = L - f0 - a - \frac{( π - 2 )}{2} b .$$

Thus, the angle θ may be calculated according to a relation

$$sin θ = \frac{( b - d )}{e} .$$

Further, a relation (1.2) may be obtained:

$$θ = arcsin \frac{b - d}{e} = arcsin \frac{b - d}{L - f 0 - a - \frac{( π 2 )}{2} b} \qquad ( 1.2 )$$

Of course, e²=(c−f0−a)²+(b−d)². Further, the angle θ may also be calculated according to a relation

$$θ = arctan \frac{b - d}{c - f 0 - a} ,$$

but through research, the inventors found that this would result in a large error.

In the relation (1.2), the semi-major axis a may be denoted by the semi-minor axis b and the minimum radius of curvature R2.

For example, corresponding to a curvilinear function y (x), the radius of curvature is

$$R = \vert \frac{{( 1 + {y}^{2} )}^{\frac{3}{2}}}{{y}^{″}} \vert ,$$

and R2 may be approximated as the minimum radius of curvature of the quasi-ellipse formed by the bendable area of the screen 20 in the bending state, Therefore,

$$R 2 \approx \frac{{b}^{2}}{a} .$$

A flexible screen mainly includes films and adhesives stacked together. Through research, the inventors also found that there would be a certain degree of compressive deformation in a final state of the waterdrop morphology of the bendable area in the bending state, resulting in a certain error compared with a theoretical value. Therefore, there is a certain difference between an approximate value and the theoretical value of the minimum radius of curvature R2. The inventors corrected the formula for the minimum radius of curvature R2 by fitting through simulation to obtain a relation (3):

$$R 2 = p * \frac{{b}^{2}}{a} \qquad ( 3 )$$

Where p is a coefficient of correction corresponding to the minimum radius of curvature R2.

The relation (3) is substituted into the relation (1.2) to obtain a relation (1.3):

$$θ = arcsin \frac{b - d}{L - f 0 - p \frac{{b}^{2}}{R 2} - \frac{( π - 2 )}{2} b} \qquad ( 1.3 )$$

The relation (1.3) is a derived relation corresponding to morphology parameters of the two-segment free-state waterdrop.

As described above, the free-state waterdrop morphology means that the bendable area of the screen is not controlled by the supporting part. For a four-segment constrained-state waterdrop, the supporting parts are arranged corresponding to both the bendable area and the non-bendable area of the screen, the supporting part arranged in the non-bendable area of the screen may control the spacing of the screen in the bending state, and the waterdrop form presented by the bendable area of the screen in the bending state may be controlled by the deflection angle of the supporting part corresponding to the bendable area.

The four-segment constrained-state waterdrop morphology may be approximated to the two-segment free-state waterdrop morphology, and the relation (1.3) may be corrected to obtain a relation corresponding to the morphology parameters of the four-segment constrained-state waterdrop. For the four-segment constrained-state waterdrop, since the supporting parts are arranged corresponding to both the bendable area and the non-bendable area of the screen, f0 in the relation (1.3) may be corrected to F, which in turn can obtain a relation (1):

$$θ = arcsin \frac{b - d}{L - F - p \frac{{b}^{2}}{R 2} - \frac{( π - 2 )}{2} b} \qquad ( 1 )$$

where F=f0+0.5X. As shown in FIG. 2, X denotes a spacing between the first supporting part 31 and the second supporting part 32 of the same supporting assembly 301 in the flat state in the first direction, and f0 denotes the length of the transition area of the first supporting part 31 in the first direction.

Through research, the inventors found that in the case of F=f0+0.5X, the coefficient of X is set to 0.5, which may correspond to a start point of the waterdrop morphology in an ideal state, being more in line with an ideal formula design and enabling a smaller design deviation.

p is related to the film-layer stacking configuration and material selection of the foldable display apparatus. As an example, the value of p may range from 1.1 to 1.2. Through extensive simulation verification, the inventors found that when p is greater than or equal to 1.1 and p is less than or equal to 1.2, the morphology parameters of the foldable display apparatus can be controllably designed using the above relation (1) to achieve a preferred or optimal waterdrop stress pattern.

R2 is also related to the film-layer stacking configuration and material selection of the foldable display apparatus. Through research, the inventors found that the minimum radius of curvature R2 may determine the risk of failure of the inorganic film layer. As an example, R2 is greater than or equal to 0.8b and R2 is less than or equal to 0.9b. Likewise, through extensive simulation verification, the inventors found that when R2 is greater than or equal to 0.8b and R2 is less than or equal to 0.9b, the morphology parameters of the foldable display apparatus can be controllably designed using the above relation (1) to achieve a preferred or optimal waterdrop stress pattern.

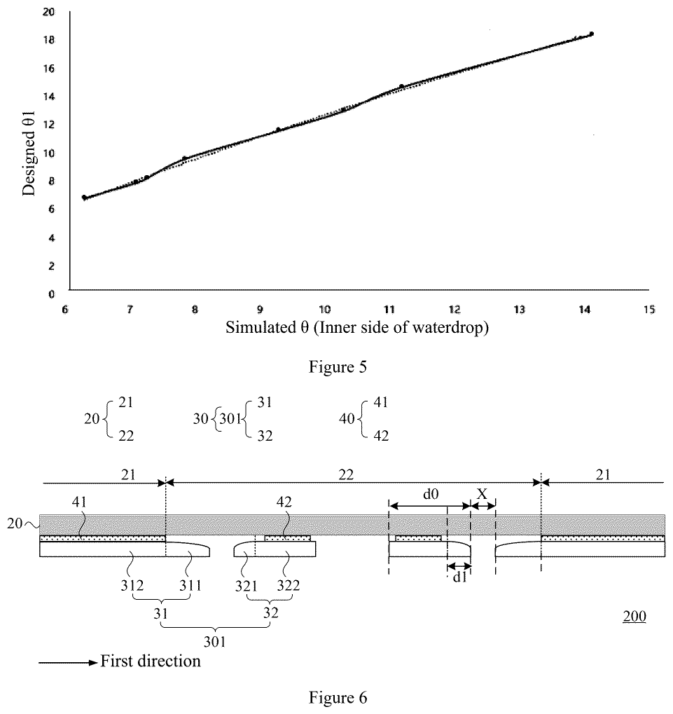

In addition, according to the theoretical formula, the stress on the screen may be optimal when the deflection angle of the second supporting part 32 is θ. However, θ in the formula (1) is determined based on the light-emitting surface of the screen, i.e., based on an inner side of the waterdrop. In contrast, for an inward-bending foldable display apparatus, in the bending state, the second supporting part 32 is located on an outer side of the waterdrop, and thus the actual deflection angle θ1 of the second supporting part 32 differs from θ in the formula (1). FIG. 5 shows a relationship between 01 and 0 obtained by simulation. In FIG. 5, a horizontal axis denotes θ and a vertical axis denotes θ1. The actual deflection angle θ1 of the second supporting part 32 and e in the formula (1) conform to a polynomial relationship. The specific relationship between θ and θ1 conforms to the following formula (4):

$$θ1 = - {t}_{1} {θ}^{2} + {t}_{2} θ - {t}_{3} \qquad ( 4 )$$

where t₁, t₂ and t₃ are all positive numbers.

In this way, an error caused by directly using e as the actual deflection angle of the second supporting part 32 may be reduced or avoided.

As shown in FIG. 3, the deflection angle θ1 of the second supporting part 32 may be understood as an angle between the light-emitting surface of the non-bendable area 21 and a side surface of the second supporting part 32 facing the screen 20.

As an example, t₁<t₂, and t₂<t₃. For example, t₁=0.032, t₂=2.1553 and t₃=5.6217.

Of course, the specific values of t₁, t₂ and t₃ can be obtained by fitting according to actual products, which is not limited in the present application.

The inventors not only derived the above relation, but also verified the accuracy of the above relation and the stress effect for the parameters determined based on the above relation.

Referring to Table 1 and Table 2, Table 1 shows design values of key parameters determined based on the above formula (1) when b=1.5, and Table 2 shows simulation results of the key parameters based on Table 1. From the simulation results, a simulated value of b matches a target value of b, verifying that the value of 0 derived from the corrected formula (1) is reasonable, that is, the formula (1) has good accuracy. As shown in FIG. 4, e denotes an approximate length of a bevel side of the waterdrop formed by the bendable area of the screen 20 in the bending state of a two-segment structure. As shown in FIG. 2, d0 denotes the length of the second supporting part 32 in the first direction in a four-segment structure. d0 may be approximately equal to e. In addition, in Tables 1 and 2, the values are given in millimeters.

TABLE 1

| | | | | |
|---|---|---|---|---|
| L | 9 | 10 | 11 | 12 |

| | |
|---|---|
| Target value of b | 1.5 |

| | | | | |
|---|---|---|---|---|
| θ | 11.6 | 9.6 | 7.8 | 6.8 |
| e/d0 | 4.3 | 5.0 | 5.6 | 6.2 |

TABLE 2

| | | | | |
|---|---|---|---|---|
| L | 9 | 10 | 11 | 12 |
| a | 1.959 | 2.096 | 2.151 | 2.224 |
| b | 1.516 | 1.496 | 1.540 | 1.573 |
| c | 7.642 | 8.685 | 9.664 | 10.650 |
| R1 | 17.307 | 24.853 | 42.975 | 58.912 |
| R2 | 1.342 | 1.278 | 1.306 | 1.341 |

Referring to Table 3, for illustration of part of parameters in Table 3, reference may be made to Table 3. As calculated according to the formula (1), X=1.8. X equals to 0.2, 0.5, 1.0, 1.5 and the values in the column, which are several design schemes listed. For each of the schemes in Table 3, the stress on the adhesive layer is obtained by simulation. The inventors found that the failure of an optically clear adhesive (OCA) is common for a foldable display apparatus of an inward-bending structure, and stresses on two optically clear adhesive layers (OCA1 and OCA2), a back supporting film (BPF) layer and a pressure-sensitive adhesive (PSA) layer are given as examples in Table 3. As an example, the foldable display apparatus may include a polarizing layer, a second OCA layer, a second cover plate, a first OCA layer and a first cover plate that are stacked on the side of the light-emitting surface of the screen and in a direction away from the light-emitting surface of the screen. The OCA1 is the first OCA layer, and the OCA2 is the second OCA layer.

By enumerating the several design schemes, an optimal stress result is found and compared with the design scheme derived from the design formula (1) in the present application. From the simulation results, it can be seen that reasonable designs of the key dimension parameters of the second supporting part and the value of the spacing X between the first supporting part and the second supporting part may optimize the stress on the adhesive layer in the foldable display apparatus. When comparing the value of the spacing X calculated from the formula with an ideal value of the spacing (the ideal value of the spacing X in Table 3 is 1.5) that results in the minimum stress on an adhesive, although there is a slight deviation, the difference is small, which indicates that the controllable design scheme for the waterdrop morphology using the formula (1) in the present application is approximate to the most ideal scheme for stress on the adhesive and can provide effective guidance for the design of the supporting part.

TABLE 3

| Design | Spacing X | 0.2 | 0.5 | 1.0 | 1.5 | 1.8 (formula- |
|---|---|---|---|---|---|---|
| parameters | | | | | | calculated |
| | | | | | | value) |
| | Angle | Θ1 | | | | |
| | Half of length of | L | | | | |
| | bendable area (mm) | | | | | |
| | Screen-to-screen spacing | D | | | | |
| | Length c of waterdrop | 10.32 | 10.34 | 10.37 | 10.40 | 10.49 |
| | (to underscreen steel | | | | | |
| | sheet) | | | | | |
| Form of | R1 (mm) | 41.38 | 42.72 | 44.13 | 44.70 | 45.01 |
| bendable | R2 (mm) | 1.68 | 1.65 | 1.60 | 1.57 | 1.56 |
| area | Width W of waterdrop | 4.27 | 4.22 | 4.11 | 4.04 | 4.01 |
| | (steel sheet to steel | | | | | |
| | sheet mm) | | | | | |
| | Radius b of simulated | 1.70 | 1.67 | 1.62 | 1.58 | 1.57 |
| | waterdrop | | | | | |
| | (inner side of | | | | | |
| | cover plate) | | | | | |
| Stress | OCA1 | 4.26E−2 | 4.13E−2 | 3.39E−2 | 3.14E−2 | 3.34E−2 |
| on | (stress Mpa) | | | | | |
| screen | OCA2 | 7.73E−2 | 7.52E−2 | 6.38E−2 | 5.99E−2 | 6.26E−2 |
| | (stress Mpa) | | | | | |
| | BPF-PSA | 9.61E−2 | 9.52E−2 | 8.25E−2 | 7.73E−2 | 8.05E−2 |
| | (stress Mpa) | | | | | |

It should be noted that only part of examples in the process of simulation are listed in Table 1 to Table 3, and do not represent the number of simulation examples.

It can be seen that the morphology parameters of the foldable display apparatus can be designed controllably using the above relation (1), and dimensions of key parameters of the foldable display apparatus can be designed and optimized to achieve an optimal waterdrop stress pattern, which can effectively avoid stress concentration in the screen, optimize the stress on the waterdrop bendable area, and alleviates the problem of peeling of the adhesive layer and the problem of fracture of the inorganic film layer.

By way of example, the key parameters of the foldable display apparatus may include the spacing X between the first supporting part 31 and the second supporting part 32 in the first direction, the deflection angle of the second supporting part 32, etc.

In one or more embodiments, the at least one established empirical formula comprises an established empirical formula (1), the at least one first feature parameter includes X, X is determined by X calculated according to the established empirical formula (1), and X and X conform to a first preset relationship:

$$θ = arcsin \frac{b - d}{L - ( f 0 + 0.5 {X}^{′} ) - p \frac{{b}^{2}}{R 2} - \frac{( π - 2 )}{2} b} \qquad ( 1 )$$

wherein the plurality of second feature parameters include θ, b, d, L, f0, p and R2.

As an example, the spacing X between the first supporting part 31 and the second supporting part 32 in the first direction may be designed using the above relation (1). For example, by setting part or all of the parameters θ, L, b, d, f0, p and R2 as fixed known values and substituting F=f0+0.5X′ into the above relation (1), the value of X′ may be calculated, and then the spacing X between the first supporting part 31 and the second supporting part 32 in the first direction may be determined based on the value of X′.

By way of example, X and X′ calculated using the formula (1) may conform to the first preset relationship. The first preset relationship may include: X is less than or equal to (1+10%) X′ and X is greater than or equal to (1-10%) X′.

In one or more embodiments, the at least one established empirical formula comprises an established empirical formula (2), the at least one first feature parameter includes the deflection angle, and the deflection angle in the at least one first feature parameter is determined according to θ, the plurality of second feature parameters include X, b, d, L, f0, p and R2, θ is determined by θ′ calculated according to the established empirical formula (2), and θ and θ′ conform to a second preset relationship:

$${θ}^{′} = arcsin \frac{b - d}{L - ( f 0 + 0.5 X ) - p \frac{{b}^{2}}{R 2} - \frac{( π - 2 )}{2} b} \qquad ( 2 )$$

Similarly, as another example, the angle θ may be designed according to θ′ calculated from a relation (2):

$${θ}^{′} = arcsin \frac{b - d}{L - F - p \frac{{b}^{2}}{R 2} - \frac{( π - 2 )}{2} b} \qquad ( 2 )$$

In one or more embodiments, the at least one established empirical formula comprises a plurality of established empirical formulas, the plurality of established empirical formulas comprise an established empirical formula (1) and an established empirical formula (2).

For example, by setting part or all of the parameters L, b, d, f0, X, p and R2 as fixed known values, and substituting F=f0+0.5X into the above relation (2), the value of θ′ may be calculated, and then the angle θ may be determined based on the value of θ′.

By way of example, θ and θ′ calculated using the formula (2) conform to a second preset relationship. The second preset relationship includes: θ is less than or equal to (1+10%) θ′ and θ is greater than or equal to (1-10%) θ′.

In one or more embodiments, in the bending state, the deflection angle of the second supporting part with respect to the first supporting part is θ1, the at least one first feature parameter includes θ1, and the angle between the light-emitting surface of the non-bendable area and the quasi-inclined surface formed by the light-emitting surface of the bendable area in the bending state is θ; and a relationship between θ and θ1 conforms to the following formula (4):

$$θ1 = - {t}_{1} {θ}^{2} + {t}_{2} θ - {t}_{3} \qquad ( 4 )$$

It should be noted that when the at least one first feature parameter includes a plurality of first feature parameters, and the plurality of first feature parameters include 01 and X, one of the parameters may be preset within a small range based on design experience, the other parameter may be obtained from the above formula, and optimization may be performed by means of simulation to obtain optimal values of 01 and X.

By way of example, the key parameters of the foldable display apparatus may further include the length of the second supporting part 32 in the first direction. As described above,

$$e = \frac{2 L - 2 f 0 - π b - 2 ( a - b )}{2} = L - f 0 - a - \frac{( π - 2 )}{2} b ,$$

and e may be approximated to the length d0 of the second supporting part in the first direction. For the four-segment constrained-state waterdrop, since the supporting parts are arranged corresponding to both the bendable area and the non-bendable area of the screen, f0 in the relation

$$e = L - f 0 - a - \frac{( π - 2 )}{2} b$$

may be corrected to F, and in turn a relation (5) may be obtained. e′ may be calculated using the following formula (5), and then d0 may be determined based on the value of e′.

$$e ’ = L - F - a - \frac{( π - 2 )}{2} b \qquad ( 5 )$$

$$where F = f 0 + 0.5 X .$$

In an embodiment of the present application, a preferred or optimal length parameter of the second supporting part may be quickly and accurately determined according to the relation (5).

Herein, the first direction may be a direction in which the non-bendable area and the bendable area are arranged in the flat state. As shown in FIG. 2, in the flat state, the adjacent non-bendable areas 21 are located on two sides of the bendable area 22 in the first direction.

By way of example, d0 and e′ calculated using the formula (5) conform to a third preset relationship. The third preset relationship includes: d0 is less than or equal to (1+10%) e′ and do is greater than or equal to (1-10%) e′.

With reference to FIGS. 2 and 3, the arc surface of the first supporting part 31 in the first transition area 311 has a radius of R4, and the arc surface of the second supporting part 32 in the second transition area 321 has a radius of R3. In the bending state, the screen 20 further includes a reverse-folded area. The position of the reverse-folded area corresponds to the position of the transition area, and the reverse-folded area has a radius of R1.

The smaller the value of the radius R3 is, the less likely the second supporting part 32 is to come into contact with the screen 20 in the second transition area 321 during folding. By way of example, R3≤R1, so that the possibility of the second transition area 321 of the second supporting part 32 pressing the screen 20 can be further reduced, to further improve the reliability of the foldable product.

Similarly, the smaller the value of the radius R4 is, the less likely the first supporting part 31 is to come into contact with the screen 20 in the first transition area 311 during folding. By way of example, R4≤R1, so that the possibility of the first transition area 311 of the first supporting part 31 pressing the screen 20 can be further reduced, to further improve the reliability of the foldable product.

As an example, R3 may be less than or equal to 10 mm, and R4 may be less than or equal to 10 mm.

As yet another example, R3 and R4 may be equal.

Of course, the values of R3 and R4 may also be designed according to actual product requirements.

In addition, the radius R1 of the reverse-folded area may determine the risk of stress failure of an adhesive. Therefore, the value of R1 may also be designed according to actual product requirements.

As shown in FIG. 2, the second transition area 321 of the second supporting part 32 has a length of d1 in the first direction. It will be understood that there may be no connecting relationship between the second transition area 321 of the second supporting part 32 and the screen 20, and the second non-transition area 322 of the second supporting part 32 and the screen 20 may be connected by means of a bonding layer.

In order to ensure that the second supporting part 32 has sufficient supporting performance for the screen 20,

$$d 1 < \frac{d 0}{2} .$$

As an example,

$$d 1 < \frac{d 0}{4} .$$

As shown in FIG. 6, the foldable display apparatus may further include a bonding layer 40. The bonding layer 40 is located between the supporting part 30 and the screen 20, and an orthographic projection of the bonding layer 40 on the screen 20 is smaller than an orthographic projection of the supporting part 30 on the screen 20. That is, the bonding layer 40 has a smaller area than the supporting part 30.

For example, the bonding layer 40 may include a first bonding section 41 and a second bonding section 42. The first bonding section 41 is located between the first supporting part 31 and the screen 20, and the second bonding section 42 is located between the second supporting part 32 and the screen 20. An orthographic projection of the first bonding section 41 on the screen 20 may be smaller than an orthographic projection of the first supporting part 31 on the screen 20, and an orthographic projection of the second bonding section 42 on the screen 20 may be smaller than an orthographic projection of the second supporting part 32 on the screen 20.

In the bending state, the light-emitting surface corresponding to an area of the bendable area bonded to the second supporting part 32 is in the form of a quasi-inclined surface, and the bendable area includes two quasi-inclined surfaces and a quasi-semielliptic cylindrical surface located between the two quasi-inclined surfaces.

The screen at the position where the bonding layer is located is equivalent to being fixed, and the larger the area of the bonding layer is, the larger the fixed area of the screen is. During folding, the supporting part may pull the screen via the bonding layer, which is likely to cause stress concentration. In an embodiment of the present application, the area of the bonding layer is set to be smaller than the area of the supporting part, which is equivalent to reducing the fixed area of the screen, so that the phenomenon of the screen being pulled during folding can be alleviated.

As an example, the orthographic projection of the bonding layer 40 on the screen 20 is located outside an orthographic projection of the transition area of the supporting part 30 on the screen 20. The orthographic projection of the bonding layer 40 on the screen 20 does not overlap the orthographic projection of the transition area of the supporting part 30 on the screen 20. In this way, there is no bonding layer 40 between the transition area of the supporting part 30 and the screen 20, which can further reduce the phenomenon of the transition area of the supporting part 30 pressing the screen 20.

By way of example, the orthographic projection of the first bonding section 41 on the screen 20 is located outside an orthographic projection of the first transition area 311 of the first supporting part 31 on the screen 20. The orthographic projection of the first bonding section 41 on the screen 20 does not overlap the orthographic projection of the first transition area 311 of the first supporting part 31 on the screen 20. By way of example, the orthographic projection of the second bonding section 42 on the screen 20 is located outside an orthographic projection of the second transition area 321 of the second supporting part 32 on the screen 20. The orthographic projection of the second bonding section 42 on the screen 20 does not overlap the orthographic projection of the second transition area 321 of the second supporting part 32 on the screen 20.

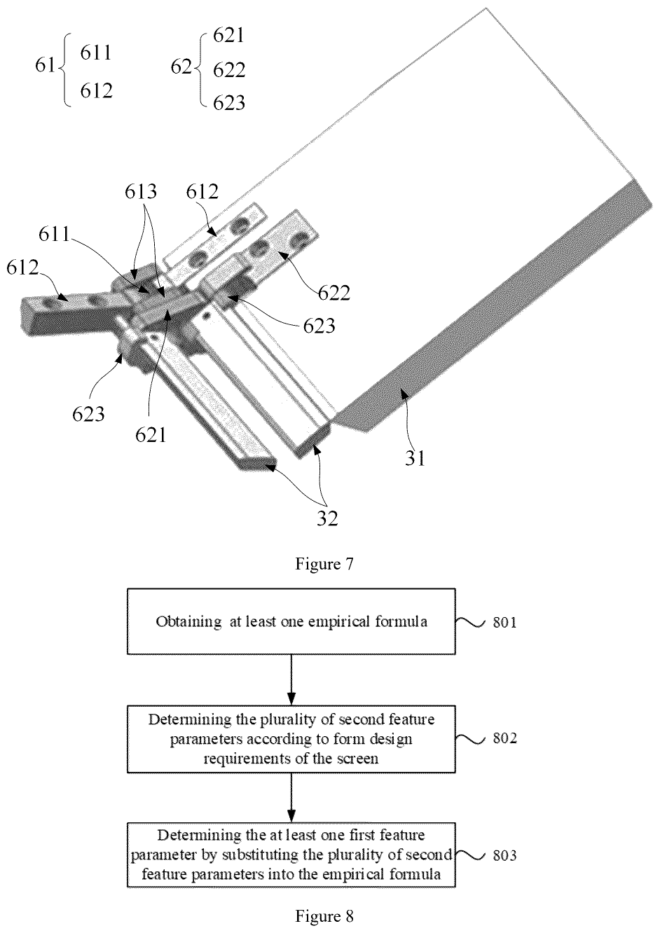

In one or more embodiments, as shown in FIG. 7, the foldable display apparatus may further include a first flipping mechanism 61 and a second flipping mechanism 62. The supporting part arranged corresponding to the non-bendable area is the first supporting part 31, and the supporting part arranged corresponding to the bendable area is the second supporting part 32. For clear illustration of the flipping mechanisms, only one first supporting part 31 is shown in FIG. 7. The first flipping mechanism 61 may be configured to control the first supporting part 31 to flip, the second flipping mechanism 62 may be configured to control the second supporting part 32 to flip relative to the first supporting part 31, and the second flipping mechanism 62 may be at least partially arranged on the first supporting part 31. In this way, the second supporting part 32 may be driven to flip by the second flipping mechanism 62 when the first supporting part 31 is flipped around a pivot.

By way of example, the first flipping mechanism 61 may include a first pivot 611 and a first bracket 612. The first bracket 612 is fixedly connected to the first supporting part 31, and one end of the first bracket 612 is connected to the first pivot 611.

For example, the first pivot 611 may be of a gear structure, and one end of the first bracket 612 may be hinged to the first pivot 611. The first flipping mechanism 61 may further include a fixing structure 613. The first pivot 611 is connected to the fixing structure 613, the fixing structure 613 is configured to fix the first pivot 611 without limiting the rotational degree of freedom of the first pivot 611, and fixing structures 613 may be provided on two sides of the first pivot 611. The first supporting part 31 may be manually flipped. Since the first supporting part 31 and the first bracket 612 are fixed relative to each other, and the first bracket 612 and the first pivot 611 may rotate relative to each other (i.e., one end of the first bracket 612 is rotatably connected to the first pivot 611), the first supporting part 31 may be flipped around the first pivot 611 when the first supporting part 31 is flipped manually. Of course, the first pivot 611 may also be controlled to rotate using an electric motor, the first pivot 611 may drive the first bracket 612 to rotate, and the first bracket 612 may drive the first supporting part 31 to rotate.

By way of example, the second flipping mechanism 62 may include a second pivot 621, a second bracket 622 and a connecting structure 623. The second bracket 622 is fixedly connected to the first supporting part 31, one end of the second bracket 622 is connected (e.g., rotatably connected) to the connecting structure 623, the connecting structure 623 is fixedly connected to the second supporting part 32, and the connecting structure 623 is connected (e.g., rotatably connected) to the second pivot 621. In this way, when the first supporting part 31 is flipped, the second bracket 622 fixed to the first supporting part 31 is flipped, the second bracket 622 drives the connecting structure 623 to flip, and in turn the connecting structure 623 drives the second supporting part 32 to flip.

By way of example, the second pivot 621 may include a slide rail (not shown), and one end of the connecting structure 623 is movably arranged inside the slide rail of the second pivot 621. In this way, the slide rail of the second pivot 621 may provide a flipping trajectory for the second supporting part 32. A flipping angle of the second supporting part 32 may be controlled by the slide rail of the second pivot 621. By way of example, an optimal flipping angle of the second supporting part 32 relative to the first supporting part 31 may be determined first, and the slide rail of the second pivot 621 may then be designed based on the optimal flipping angle.

The connecting structure 623 may include a pin structure, and the pin structure of the connecting structure 623 is movably arranged inside the slide rail of the second pivot 621.

A flipping structure shown in FIG. 7 is merely an example and is not intended to limit the present application.

An embodiment of the present application provides a method for manufacturing a foldable display apparatus, which can be used for manufacturing the foldable display apparatus as described in the embodiments, the foldable display apparatus having a flat state and a bending state. As shown in FIG. 8, the method for manufacturing a foldable display apparatus provided in the embodiment of the present application may include the following S801 to S803:

S801: obtaining at least one empirical formula, each of the at least one empirical formula including at least one first feature parameter and a plurality of second feature parameters, the at least one first feature parameter being design parameter of the supporting structure and including at least a spacing between the first supporting part and the second supporting part in the flat state or a deflection angle of the second supporting part relative to the first supporting part in the bending state;

S802: determining the plurality of second feature parameters according to form design requirements of the screen; and

S803: determining the at least one first feature parameter by substituting the plurality of second feature parameters into the empirical formula.

According to the method for manufacturing a foldable display apparatus provided in the embodiment of the present application, instead of arbitrarily setting parameters of the supporting structure, morphology parameters of the foldable display apparatus are designed controllably according to the established empirical formula, so that dimensions of key parameters of the foldable display apparatus can be optimized and designed to help to achieve an optimal waterdrop stress pattern, which can help to avoid stress concentration in the screen, optimize the stress on the waterdrop bendable area, and alleviate the problem of peeling of the adhesive layer and the problem of fracture of the inorganic film layer.

By way of example, the first supporting part includes a transition area, the transition area being close to the second supporting part, and a surface of the first supporting part facing the screen in the transition area being an arc surface;
in the flat state, the adjacent non-bendable areas are located on two sides of the bendable area in the first direction, the spacing between the first supporting part and the second supporting part of the same supporting assembly in the flat state in the first direction is X, the at least one first feature parameter includes X, and S803 may specifically include:
substituting the plurality of second feature parameters into an empirical formula (1) and determining X according to X;

$$θ = arcsin \frac{b - d}{L - ( f 0 + 0.5 {X}^{′} ) - p \frac{{b}^{2}}{R 2} - \frac{( π - 2 )}{2} b} \qquad ( 1 )$$

where the plurality of second feature parameters include θ, b, d, L, f0, p and R2, in the bending state, a light-emitting surface of the bendable area forms a quasi-semielliptic cylindrical surface and quasi-inclined surfaces on two sides of the quasi-semielliptic cylindrical surface, each second supporting part is arranged to partially or wholly correspond to a quasi-inclined surface, θ denotes an angle between a light-emitting surface of the non-bendable area and the quasi-inclined surface in the bending state, the angle between the light-emitting surface of the non-bendable area and the quasi-inclined surface in the bending state is the deflection angle, b denotes a semi-minor axis of the quasi-semielliptic cylindrical surface formed by the light-emitting surface of the bendable area in the bending state, and d denotes half of a spacing between the light-emitting surfaces of the two non-bendable areas in the bending state; L denotes half of a length of the bendable area in the first direction, f0 denotes a length of the transition area of the first supporting part in the first direction, R2 denotes a minimum radius of curvature of the quasi-semielliptic cylindrical surface formed by the bendable area in the bending state, and P is a coefficient of correction corresponding to the minimum radius of curvature; and b is equal to half of a spacing between two opposite ends in the first direction of the quasi-semielliptic cylindrical surface formed by the light-emitting surface of the bendable area in the bending state;
or the at least one first feature parameter include a deflection angle θ1 of the second supporting part relative to the first supporting part in the bending state, the deflection angle in the at least one first feature parameter is determined according to θ, the plurality of second feature parameters include X, b, d, L, f0, p and R2, and S803 may specifically include:
substituting the plurality of second feature parameters into an empirical formula (2) and determining θ according to θ′; and
determining θ1 according to θ;

$${θ}^{′} = arcsin \frac{b - d}{L - ( f 0 + 0.5 X ) - p \frac{{b}^{2}}{R 2} - \frac{( π - 2 )}{2} b} \qquad ( 2 )$$

By way of example, X is less than or equal to (1+10%) X and X is greater than or equal to (1-10%) X′.

By way of example, θ is less than or equal to (1+10%) θ′ and θ is greater than or equal to (1-10%) θ′.

By way of example, p is greater than or equal to 1.1 and p is less than or equal to 1.2.

By way of example, R2 conforms to the following formula (3):

$$R 2 = p * \frac{{b}^{2}}{a} \qquad ( 3 )$$

where a denotes a semi-major axis of the quasi-semielliptic cylindrical surface formed by the light-emitting surface of the bendable area in the bending state.

By way of example, R2 is greater than or equal to 0.8b and R2 is less than or equal to 0.9b.

By way of example, in the bending state, the light-emitting surface of the screen is located inside of a non-light-emitting surface of the screen opposite the light-emitting surface.

By way of example, determining θ1 according to e includes:

determining θ1 according to a formula (4):

$$θ1 = - {t}_{1} {θ}^{2} + {t}_{2} θ - {t}_{3} \qquad ( 4 )$$

where t₁, t₂ and t₃ are all positive numbers.

By way of example, the deflection angle θ1 of the second supporting part is equal to an angle between the light-emitting surface of the non-bendable area and a side surface of the second supporting part facing the screen.

By way of example, t₁<t₂, and t₂<t₃.

By way of example, t₁=0.032, t₂=2.1553 and t₃=5.6217.

By way of example, the second supporting part includes a transition area, the transition area of the second supporting part being close to the second supporting part, and a surface of the first supporting part facing the screen in the transition area being an arc surface; and
the second supporting part has a length of do in the first direction, and the method further includes:
determining d0 according to e′ of a formula (5):

$$e ’ = L - F - a - \frac{( π - 2 )}{2} b \qquad ( 5 )$$

By way of example, do is less than or equal to (1+10%) e′ and d0 is greater than or equal to (1-10%) e′.

The transition area of the second supporting part has a length of d1 in the first direction, and

$$d 1 < \frac{d 0}{2} ;$$

and by way of example,

$$d 1 < \frac{d 0}{4} .$$

In the method for manufacturing a foldable display apparatus provided in the embodiment of the present application, the details of the process of deriving each formula can be found in the above description of the embodiments of the foldable display apparatus, and will not be repeated herein.

The present application further provides an electronic device, including a foldable display apparatus as described in any one of the above embodiments of the present application. It will be understood that the electronic device provided in the embodiment of the present application may be a mobile phone, a tablet, a computer, a television or other electronic devices with display functions, which will not be specifically limited in the present application. The electronic device provided in the embodiment of the present application has the beneficial effects of the foldable display apparatus provided in the embodiments of the present application, and reference may be made to the specific description of the foldable display apparatus in the above embodiments, which is not repeated herein in this embodiment.

1. A foldable display apparatus having a flat state and a bending state, comprising:
a screen comprising two non-bendable areas and a bendable area located between adjacent non-bendable areas, in the flat state, the adjacent non-bendable areas being located on two sides of the bendable area in a first direction; and
a supporting structure comprising two supporting assemblies, the two supporting assemblies being located on two sides of a bending axis of the bendable area, respectively, each supporting assembly comprising a first supporting part and a second supporting part spaced apart from each other, each first supporting part being arranged to at least partially correspond to a non-bendable area, and each second supporting part being arranged on a side of the bendable area away from the bending axis,
wherein the supporting structure is designed according to at least one established empirical formula, each of the at least one established empirical formula comprising at least one first feature parameter and a plurality of second feature parameters, the at least one first feature parameter being design parameter of the supporting structure and comprising at least a spacing between the first supporting part and the second supporting part in the flat state or a deflection angle of the second supporting part relative to the first supporting part in the bending state; and the plurality of second feature parameters being determined according to form design requirements of the screen.

2. The foldable display apparatus according to claim 1, wherein
the first supporting part comprises a transition area, the transition area of the first supporting part being close to the second supporting part, and a surface of the first supporting part facing the screen in the transition area being an arc surface; the spacing between the first supporting part and the second supporting part of the same supporting assembly in the flat state in the first direction is X, the at least one established empirical formula comprises an established empirical formula (1), the at least one first feature parameter comprises X, X is determined by X calculated according to the established empirical formula (1), and X and X conform to a first preset relationship:
$$θ = arcsin \frac{b - d}{L - ( f 0 + 0.5 {X}^{′} ) - p \frac{{b}^{2}}{R 2} - \frac{( π - 2 )}{2} b} \qquad ( 1 )$$
wherein the plurality of second feature parameters comprise θ, b, d, L, f0, p and R2, in the bending state, a light-emitting surface of the bendable area forms a quasi-semielliptic cylindrical surface and quasi-inclined surfaces on two sides of the quasi-semielliptic cylindrical surface, each second supporting part is arranged to at least partially correspond to a quasi-inclined surface, θ denotes an angle between a light-emitting surface of the non-bendable area and the quasi-inclined surface in the bending state, b denotes a semi-minor axis of the quasi-semielliptic cylindrical surface formed by the light-emitting surface of the bendable area in the bending state, and d denotes half of a spacing between the light-emitting surfaces of the two non-bendable areas in the bending state; L denotes half of a length of the bendable area in the first direction, f0 denotes a length of the transition area of the first supporting part in the first direction, R2 denotes a minimum radius of curvature of the quasi-semielliptic cylindrical surface formed by the bendable area in the bending state, and P is a coefficient of correction corresponding to the minimum radius of curvature; and b is equal to half of a spacing between two opposite ends in the first direction of the quasi-semielliptic cylindrical surface formed by the light-emitting surface of the bendable area in the bending state;
or the at least one established empirical formula comprises an established empirical formula (2), the deflection angle in the at least one first feature parameter is determined according to θ, the plurality of second feature parameters comprise X, b, d, L, f0, p and R2, θ is determined by θ′ calculated according to the established empirical formula (2), and θ and θ′ conform to a second preset relationship:
$$θ ’ = arcsin \frac{b - d}{L - ( f 0 + 0.5 X ) - p \frac{{b}^{2}}{R 2} - \frac{( π - 2 )}{2} b} . \qquad ( 2 )$$

3. The foldable display apparatus according to claim 2, wherein
the first preset relationship comprises: X is less than or equal to (1+10%) X and X is greater than or equal to (1-10%) X; and
the second preset relationship comprises: θ is less than or equal to (1+10%) θ′ and θ is greater than or equal to (1-10%) θ′.

4. The foldable display apparatus according to claim 2, wherein
p is greater than or equal to 1.1 and p is less than or equal to 1.2.

5. The foldable display apparatus according to claim 2, wherein
R2 conforms to the following formula:
$$R 2 = p * \frac{{b}^{2}}{a} \qquad ( 3 )$$
where a denotes a semi-major axis of the quasi-semielliptic cylindrical surface formed by the light-emitting surface of the bendable area in the bending state.

6. The foldable display apparatus according to claim 5, wherein
R2 is greater than or equal to 0.8b and R2 is less than or equal to 0.9b.

7. The foldable display apparatus according to claim 1, wherein
in the bending state, a light-emitting surface of the screen is located inside of a non-light-emitting surface of the screen opposite the light-emitting surface.

8. The foldable display apparatus according to claim 2, wherein
in the bending state, the deflection angle of the second supporting part relative to the first supporting part is θ1, and the at least one first feature parameter further comprises θ1;
a relationship between θ and θ1 conforms to the following formula (4):
$$θ 1 = - {t}_{1} {θ}^{2} + {t}_{2} θ - {t}_{3} \qquad ( 4 )$$
where t₁, t₂ and t₃ are all positive numbers; and
the deflection angle θ1 of the second supporting part is equal to an angle between the light-emitting surface of the non-bendable area and a side surface of the second supporting part facing the screen.

9. The foldable display apparatus according to claim 8, wherein
t₁<t₂, and t₂<t₃.

10. The foldable display apparatus according to claim 8, wherein
t₁=0.032, t₂=2.1553 and t₃=5.6217.

11. The foldable display apparatus according to claim 1, further comprising a first flipping mechanism and a second flipping mechanism, wherein a supporting part arranged corresponding to the non-bendable area is the first supporting part, a supporting part arranged corresponding to the bendable area is the second supporting part, the first flipping mechanism controls the first supporting part to flip, the second flipping mechanism controls the second supporting part to flip relative to the first supporting part, and the second flipping mechanism is at least partially arranged on the first supporting part;
the first flipping mechanism comprises a first pivot and a first bracket, the first bracket being fixedly connected to the first supporting part, and one end of the first bracket being connected to the first pivot;
the second flipping mechanism comprises a second pivot, a second bracket and a connecting structure, the second bracket being fixedly connected to the first supporting part, one end of the second bracket being connected to the connecting structure, the connecting structure being fixedly connected to the second supporting part, and the connecting structure being connected to the second pivot; and
the second pivot comprises a slide rail, one end of the connecting structure being movably arranged inside the slide rail of the second pivot.

12. The foldable display apparatus according to claim 2, wherein the second supporting part has a length of d0 in the first direction,
do and e′ calculated using the following formula (5) conform to a third preset relationship:
$$e ’ = L - F - a \frac{( π - 2 )}{2} b \qquad ( 5 )$$
$$where F = f 0 + 0.5 X ,$$
and
the third preset relationship comprises: d0 is less than or equal to (1+10%) e′ and do is greater than or equal to (1-10%) e′.

13. The foldable display apparatus according to claim 1, wherein each of the first supporting part and the second supporting part comprises a transition area, the transition area of the first supporting part being close to the second supporting part, the transition area of the second supporting part being close to the first supporting part, and a surface of the first supporting part facing the screen in the transition area being an arc surface; a surface of the second supporting part facing the screen in the transition area is an arc surface; the arc surface of the first supporting part in the transition area has a radius of R4, and the arc surface of the second supporting part in the transition area has a radius of R3;
in the bending state, the screen further comprises a reverse-folded area, the reverse-folded area corresponding to the transition area, and the reverse-folded area having a radius of R1;
R3≤R1; and
R4≤R1.

14. The foldable display apparatus according to claim 13, wherein R3 is less than or equal to 10 mm; and R4 is less than or equal to 10 mm; and
R3=R4.

15. The foldable display apparatus according to claim 13, wherein the second supporting part has a length of d0 in the first direction, the transition area of the second supporting part has a length of d1 in the first direction, and
$$d 1 < \frac{d 0}{2} .$$

16. The foldable display apparatus according to claim 2, wherein the arc surface protrudes toward the screen; the foldable display apparatus comprises the flat state and the bending state, in the flat state, in the same supporting assembly, a gap between the arc surface of the supporting part having the transition area and the screen gradually increasing in a direction from the supporting part toward the other supporting part;
the supporting structure is located on the side of a non-light-emitting surface of the screen opposite the light-emitting surface;
the foldable display apparatus further comprises a bonding layer, the bonding layer being located between the supporting part and the screen;
an orthographic projection of the bonding layer on the screen is smaller than an orthographic projection of the supporting part on the screen; and the orthographic projection of the bonding layer on the screen is located outside an orthographic projection of the transition area of the supporting part on the screen.

17. A method for manufacturing a foldable display apparatus having a flat state and a bending state, the foldable display apparatus comprising:
a screen comprising two non-bendable areas and a bendable area located between adjacent non-bendable areas, in the flat state, the adjacent non-bendable areas being located on two sides of the bendable area in a first direction; and
a supporting structure comprising two supporting assemblies, the two supporting assemblies being located on two sides of a bending axis of the bendable area, respectively, each supporting assembly comprising a first supporting part and a second supporting part spaced apart from each other, each first supporting part being arranged to at least partially correspond to a non-bendable area, and each second supporting part being arranged on a side of the bendable area away from the bending axis; and the method comprising:
obtaining at least one empirical formula, each of the at least one empirical formula comprising at least one first feature parameter and a plurality of second feature parameters, the at least one first feature parameter being design parameter of the supporting structure and comprising at least a spacing between the first supporting part and the second supporting part in the flat state or a deflection angle of the second supporting part relative to the first supporting part in the bending state;
determining the plurality of second feature parameters according to form design requirements of the screen; and
determining the at least one first feature parameter by substituting the plurality of second feature parameters into the empirical formula.

18. The method according to claim 17, wherein the first supporting part comprises a transition area, the transition area being close to the second supporting part, and a surface of the first supporting part facing the screen in the transition area being an arc surface;
the spacing between the first supporting part and the second supporting part of the same supporting assembly in the flat state in the first direction is X, the at least one first feature parameter comprises X, and determining the at least one first feature parameter by substituting the plurality of second feature parameters into the empirical formula comprises:
substituting the plurality of second feature parameters into an empirical formula (1) and determining X according to X;
$$θ = arcsin \frac{b - d}{L - ( f 0 + 0.5 {X}^{′} ) - p \frac{{b}^{2}}{R 2} - \frac{( π - 2 )}{2} b} \qquad ( 1 )$$
wherein the plurality of second feature parameters comprises θ, b, d, L, f0, p and R2, in the bending state, a light-emitting surface of the bendable area forms a quasi-semielliptic cylindrical surface and quasi-inclined surfaces on two sides of the quasi-semielliptic cylindrical surface, each second supporting part is arranged to at least partially correspond to a quasi-inclined surface, θ denotes an angle between a light-emitting surface of the non-bendable area and the quasi-inclined surface in the bending state, the angle between the light-emitting surface of the non-bendable area and the quasi-inclined surface in the bending state is the deflection angle, b denotes a semi-minor axis of the quasi-semielliptic cylindrical surface formed by the light-emitting surface of the bendable area in the bending state, and d denotes half of a spacing between the light-emitting surfaces of the two non-bendable areas in the bending state; L denotes half of a length of the bendable area in the first direction, f0 denotes a length of the transition area of the first supporting part in the first direction, R2 denotes a minimum radius of curvature of the quasi-semielliptic cylindrical surface formed by the bendable area in the bending state, and P is a coefficient of correction corresponding to the minimum radius of curvature; and b is equal to half of a spacing between two opposite ends in the first direction of the quasi-semielliptic cylindrical surface formed by the light-emitting surface of the bendable area in the bending state;
and the at least one first feature parameter comprises a deflection angle θ1 of the second supporting part relative to the first supporting part in the bending state, the plurality of second feature parameters comprise X, b, d, L, f0, p and R2, and determining the at least one first feature parameter by substituting the plurality of second feature parameters into the empirical formula comprises:
substituting the plurality of second feature parameters into an empirical formula (2) and determining θ according to θ′; and
determining θ1 according to θ;
$$θ ’ = arcsin \frac{b - d}{L - ( f 0 + 0.5 X ) - p \frac{{b}^{2}}{R 2} - \frac{( π - 2 )}{2} b} . \qquad ( 2 )$$
X is less than or equal to (1+10%) X and X is greater than or equal to (1-10%) X;
θ is less than or equal to (1+10%) θ′ and θ is greater than or equal to (1-10%) θ′;
p is greater than or equal to 1.1 and p is less than or equal to 1.2;
R2 conforms to the following formula:
$$R 2 = p * \frac{{b}^{2}}{a} \qquad ( 3 )$$
where a denotes a semi-major axis of the quasi-semielliptic cylindrical surface formed by the light-emitting surface of the bendable area in the bending state;
R2 is greater than or equal to 0.8b and R2 is less than or equal to 0.9b;
in the bending state, the light-emitting surface of the screen is located inside of a non-light-emitting surface of the screen opposite the light-emitting surface;
determining θ1 according to θ comprises:
determining θ1 according to a formula (4):
$$θ 1 = - {t}_{1} {θ}^{2} + {t}_{2} θ - {t}_{3} \qquad ( 4 )$$
where t₁, t₂ and t₃ are all positive numbers;
the deflection angle θ1 of the second supporting part is equal to an angle between the light-emitting surface of the non-bendable area and a side surface of the second supporting part facing the screen;
t₁<t₂, and t₂<t₃; and
t₁=0.032, t₂=2.1553 and t₃=5.6217.

19. The method according to claim 18, wherein the second supporting part comprises a transition area, the transition area of the second supporting part being close to the first supporting part, and a surface of the second supporting part facing the screen in the transition area being an arc surface;
the second supporting part has a length of do in the first direction, and the method further comprises:
determining do according to e′ of a formula (5):
$$e ’ = L - F - a \frac{( π - 2 )}{2} b \qquad ( 5 )$$
do is less than or equal to (1+10%) e′ and d0 is greater than or equal to (1-10%) e′; and
the transition area of the second supporting part has a length of d1 in the first direction, and
$$d 1 < \frac{d 0}{2} .$$

20. An electronic device, comprising a foldable display apparatus according to claim 1.
